(19) United States
(12) Patent Application Publication
(10) Pub. No.: US 2025/0061664 A1
(43) Pub. Date: Feb. 20, 2025

(54) SYSTEM AND METHOD FOR DISPLAYING IMAGES TO AN AUGMENTED REALITY HEADS-UP DISPLAY RENDERING

(71) Applicant: Harman International Industries, Incorporated, Stamford, CT (US)

(72) Inventors: Robert Haase, Brighton, MI (US); Rhita Boufelliga, Farmington Hill, MI (US); Yeshvanth Narahari Venkatasubramanya, Farmington, MI (US)

(21) Appl. No.: 18/723,379

(22) PCT Filed: Dec. 22, 2021
(86) PCT No.: PCT/US2021/073091

§ 371 Date: Jun. 21, 2024

(51) Int. Cl. G06T 19/00; G02B 27/01; G06T 19/20

(52) U.S. Cl. CPC G06T 19/006; G02B 27/017; G06T 19/20; G06T 2219/2004; G06T 2219/2016

(57) ABSTRACT

Embodiments are disclosed for display configurations for providing an augmented reality heads-up display. In one or more examples, a heads-up display device includes at least one display and the heads-up display updates sizes and positions of virtual objects multiple times for each image that is captured via a camera. The virtual objects may be updated based on a trajectory of an object in the real-world.

### FIELD

The disclosure relates to displaying images to an augmented reality heads-up display.

### BACKGROUND

A heads-up display (HUD) may show vehicle occupants data or information without the vehicle occupants having to take their eyes away from a direction of vehicle travel. This allows a heads-up display to provide pertinent information to vehicle occupants in a way that may be less distracting than displaying the same information to a control console that may be out of their field of vision. The heads-up display may utilize augmented reality systems to insert virtual (e.g., computer-generated) objects into a field of view of a user in order to make the virtual objects appear to the user to be integrated into a real-world environment. The objects may include but are not limited to signs, people, vehicles, and traffic signals.

### SUMMARY

A see-through display may include virtual objects that are placed in a user's field of view according to objects that are detected via a camera. There is a finite amount of time between when an image is captured via the camera and when a virtual object that is related to an objected that is detected from the image is exhibited or viewable via a vehicle HUD. This time may be referred to as a glass to glass latency of the HUD system. The glass to glass latency may cause virtual objects that move with objects detected from the image to appear to move in a step-wise manner. Consequently, the motion of the virtual object in the HUD image when presented via the augmented reality system may not flow smoothly such that the image may be less realistic and/or less pleasing to the viewer. By updating an exhibited or displayed image with expected or projected virtual objects between times when images are captured via a camera, it may be possible to provide smoother motion for exhibited or displayed virtual objects that follow motion of objects in images captured by the camera. The present disclosure provides for a heads-up display device comprising: a display; a camera; and a display controller comprising a processor and memory storing non-transitory instructions executable by the processor to exhibit one or more virtual objects via the display, the one or more virtual objects generated via the processor, the one or more virtual objects exhibited in displayed images via the display at a rate faster than new images are captured via the camera, and where positions of the one or more virtual objects are adjusted in each of the displayed images each time the displayed images are updated. In this way, it may be possible to smoothly move a virtual object in a HUD image to track with an object that is captured via a camera.

In some examples, the new images that are captured at a fixed rate, the fixed rate may be related to system hardware and software throughput limits. The heads-up display device may also include wherein a position of the one or more virtual objects is based on a position of an identified object in an image captured via a camera, and wherein the one or more virtual objects are configured to make an object in the real-world more noticeable. The heads-up display device may include where the one or more objects appear to surround the object in the real-world to allow quicker identification of the second object by a user. The heads-up display device may also include where the one or more objects are placed to appear proximate to the object in the real-world via the heads-up display so as to allow a user to recognize the second object sooner. The heads-up display device may also include additional instructions to position the one or more virtual objects generated via the processor via the heads-up display based on a trajectory of a first identified object captured in a first image via the camera and the first identified object captured in a second image via the camera so that the virtual object may track or follow the second object as the second object moves in the real-world. The heads-up display device may also include where the trajectory of the first identified object is based on a position of the first identified object in the first image and a position of the first identified object in the second image. A change in the position of the second object may be the basis for predicting a future position of the second object so that the heads-up display system may track or follow the second object even when additional images of the second object are not captured by the camera. The heads-up display further comprises additional instructions to resize the one or more virtual objects in response to the trajectory of the first identified object.

A heads-up display system may include a camera to detect positions of objects in fields of view of vehicle occupants. The camera may generate images in which objects may be identified and the identified objects may be highlighted in a user's field of view via the heads-up display system generating a virtual object via light, such as a target box or other visual aid. The user may observe an identified object through a wind shield and a see-through virtual object may be generated in the user's field of view and in the heads-up display field of projection such that the virtual object appears to surround and/or follow the identified object from a user's point of view. However, the amount of time it takes to capture an image via the camera, identify objects in the captured image, render virtual objects, and display the virtual objects in a user's field of view may be longer than an amount of time it takes for a user to notice motion of the virtual object that is generated to call attention to the user. Consequently, the user may notice stepwise changes in the position of the virtual object. The present disclosure may provide ways of overcoming such limitations.

As one example, the present disclosure provides for a method for operating a heads-up display device, the method comprising: capturing a first image via a camera; identifying an object in the first image; generating a display image via a heads-up display, the display image including a virtual object that is placed in the display image based on a motion of the object. By placing the virtual object in the display image (e.g., an image that is projected via the heads-up display) based on the motion of the object, it may be possible to smoothly track the object with a virtual object in a user's field of view. In other words, the virtual object may appear to move continuously with the object so as to improve tracking of the object from the user's point of view.

In some examples, the method includes where the motion of the object is based on a trajectory of the object, and further comprises capturing a second image via the camera and identifying the object in the second image. The method further comprises estimating the motion of the object based on the first and second images so that the virtual object may be placed in a desired location in a user's field of view without having to capture a new image each time the virtual object's position is adjusted. The method also further comprises adjusting a position of the virtual object in the display image based on the motion of the object. The method further comprises adjusting a size of the virtual object based on a speed of a vehicle. This allows the virtual object to grow or shrink as an identified object grows or shrinks so that the size of the virtual object is adjusted with the size of the identified object according to the user's field of view. The method includes where the virtual object is configured to enhance visual identification of the object so that the user may be made aware of the identified object. The method includes where placing the virtual object in the display image based on the motion of the object includes placing the virtual object in the display image based on a location the object is expected to be relative to a user field of view, the location the object is expected to be being based on a position of the object in the first image. In this way, the virtual object may be moved without having to capture and process another image.

A heads-up display may track a position of an object via a camera and provide a virtual object in a field of view. However, by the time that the camera image is processed and an object in the image is identified, a virtual objected that is placed in a field of view of a user based on the object in the image may be placed in a position that is different than the current position of the object in the user's field of view. Therefore, it may be desirable to adjust the position of the virtual object in the user's field of view such that the virtual object may track or follow the object in the user's field of view more closely. The present disclosure may provide a way of making a virtual object appear to more closely follow an object in a user's field of view.

In one or more examples, the present method provides for a method for operating a heads-up display device, the method comprising: capturing a first image via a camera; identifying a position of an object in the first image; generating a second image via a heads-up display, the second image including a virtual object that is placed in the second image at a first position based on the position of the object in the first image; capturing a third image via the camera; identifying a position of the object in the third image; generating a fourth image via a heads-up display, the fourth image including the virtual object that is placed in the fourth image at a second position based on the position of the object in the third image; and generating a plurality of images via a heads-up display, the plurality of images generated at times between generation of the second image and generation of the fourth image, the plurality of images including the virtual object, the virtual object placed in the plurality of images based on expected positions of the object, the expected positions of the object located between the first position and the second position.

In some examples, the method includes where the expected positions of the object are based on the position of the object in the first image. In particular, the expected position of the object may be interpolated such that the virtual object may be placed near the object in the user's field of view. The method also includes where the expected positions of the object are based on the position of the object in an image captured via the camera before the first image. Thus, the interpolated position of the object may be based on known first and second positions of the object that were determined ahead of the interpolated position of the object. The method also further comprises adjusting a size of the virtual object based on a change in a size of the object. This may allow the virtual object to scale with the object in the user's field of view so that a size relationship between the object and the virtual object in the user's field of view may be maintained. In addition, the method further comprises estimating a position change of the object so that a position of the object at a future time may be estimated.

### BRIEF DESCRIPTION OF THE DRAWINGS

The disclosure may be better understood from reading the following description of non-limiting embodiments, with reference to the attached drawings, wherein below:

FIG. 1 shows an example block diagram of a mirrorless display configuration in accordance with one or more embodiments of the present disclosure;

FIGS. 2A-2E show example schematic views of a mirrorless display configuration in a vehicle cabin for projecting images in accordance with one or more embodiments of the present disclosure;

FIG. 3 shows an example sequence and timing diagram for exhibiting virtual objects in a heads-up display in accordance with one or more embodiments of the present disclosure;

FIGS. 4 and 5 show example flow charts for methods of adjusting operation of a display in accordance with one or more embodiments of the present disclosure; and

FIGS. 6 and 7 show how an object may be captured via a digital image and tracked for displaying a virtual object or image.

### DETAILED DESCRIPTION

The disclosure provides for systems and methods that address the above-described issues that may arise in producing a heads-up display in an environment such as a vehicle. For example, the disclosure describes a display configuration that identifies objects in a user's field of view and generates virtual objects that may track or follow the identified objects so as to make the identified objects more noticeable to users. The virtual objects may be aligned with and/or positioned over and/or around identified objects in a user's optical path such that the virtual objects flow with the identified objects in the user's optical path in a way that may be visually pleasing to a user. The virtual objects may be placed in the user's optical path via a heads-up display according to estimated trajectories of the identified objects without having to deploy high speed image processing. In one or more examples, positions of virtual objects may be adjusted without capturing an image and identifying objects in the image each time the virtual objects are moved. As such, the amount of image processing to operate the heads-up display may be reduced. In addition, lowering the image processing requirements may reduce system cost.

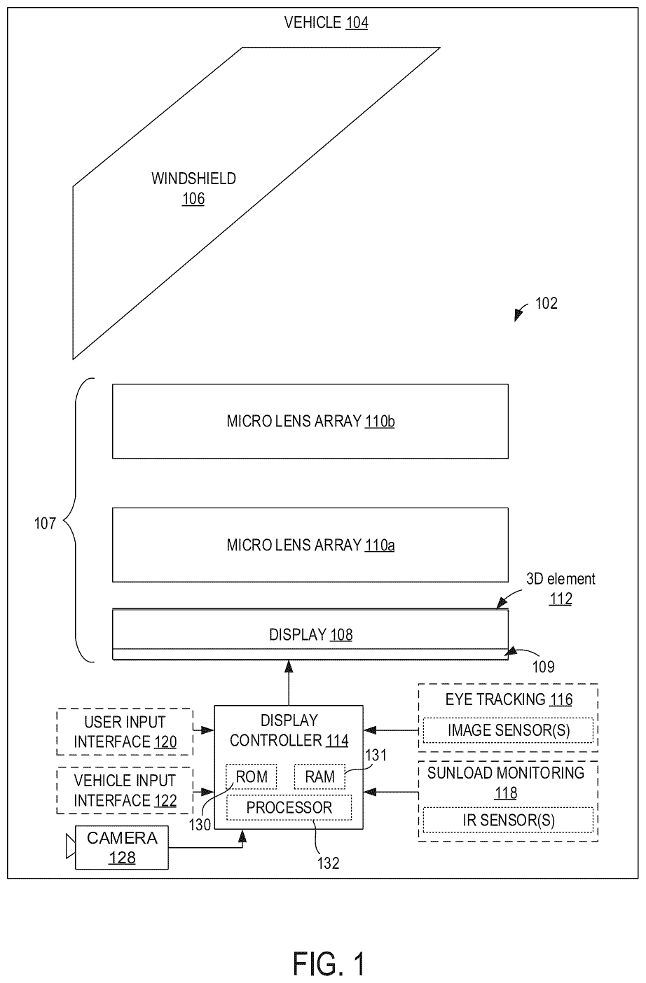

FIG. 1 shows an example mirrorless three-dimensional display system 102 for projecting see-through images to one or more users (e.g., vehicle occupants). The display system 102 of FIG. 1 may be included inside a vehicle 104 and configured to project light onto and/or through a windshield 106. The display configuration may include a display 108, one or more micro lens arrays 110a and 110b, and a three-dimensional element 112 positioned between the display 108 and micro lens array 110a. The three-dimensional element 112 may include a parallaxial or lenticular element (e.g., film) that generates auto-stereoscopic images from the output of display 108. The display 108 may include transmissive display technology (e.g., a liquid crystal display, LCD) and/or micro element-based display technology (e.g., digital light processing microelectromechanical system, DLP MEMS). The micro lens array(s) may be positioned relative to the windshield 106 such that an entirety of the windshield 106 or a selected portion of the windshield 106 serves as a display surface (e.g., a transparent plane onto which three-dimensional display images may be projected). In this way, the field of projection of the display system may be sized according to the number and arrangement of micro lens arrays, which may provide for a display that has a larger field of projection than other configurations (e.g., mirrored configurations). The display 108 may be illuminated via a backlight array 109, which includes a matrix of light sources (e.g., light-emitting diodes) distributed along a back of the display 108. As shown, the display 108, backlight 109, 3D element 112, and micro lens array(s) 110a and/or 110b may collectively form a display unit 107. Although shown separately, in some examples, display controller 114 may also be included in the display unit 107.

The display 108 may be controlled via a display controller 114. The display controller 114 may be a dedicated display controller (e.g., a dedicated electronic control unit that only controls the display) or a combined controller (e.g., a shared electronic control unit that controls the display and one or more other vehicle systems). In some examples, the display controller 114 may be a head unit of the vehicle 104 (e.g., an infotainment unit and/or other in-vehicle computing system). The display controller may include non-transitory memory (e.g., read-only memory) 130, random access memory 131, and a processor 132 for executing instructions stored in the memory to control an output of the display 108. The display controller 114 may control the display 108 to project particular images based on the instructions stored in memory and/or based on other inputs. The display controller 114 may also control the display 108 to selectively turn off (e.g., dim) portions of backlighting from the backlight array 109 to conserve power and/or reduce heat based on a state of the display and/or ambient conditions of the display. For example, when regions of an image are black, portions of the backlight array 109 corresponding to the locations of the black regions of the images may be turned off. As another example, if a thermal load is predicted or detected to be above a threshold, selected light sources of the backlight array 109 may be turned off to reduce heat generation (e.g., alternating light sources in the array may be switched off so that the whole image may be displayed while only half of the light sources are generating heat, or the image may be reduced in size and light sources in the array corresponding to locations of newly black regions of the image may be turned off). Examples of inputs to the display controller 114 to control mechanism of display 108 include an eye tracking module 116, a sunload monitoring module 118, a user input interface 120, camera 128, and a vehicle input interface 122.

Eye tracking module 116 may include and/or be in communication with one or more image sensors to track movement of eyes of a user (e.g., a driver). For example, one or more image sensors may be mounted in a cabin of the vehicle 104 and positioned to capture (e.g., continuously) images of pupils or other eye features of a user in the vehicle. In some examples, the image data from the image sensors tracking the eyes may be sent to the display controller for processing to determine a gaze direction and/or other eye tracking details. In other examples, the eye tracking module 116 may include and/or may be in communication with one or more processing modules (e.g., local modules within the vehicle, such as a processing module of a head unit of the vehicle, and/or remote modules outside of the vehicle, such as a cloud-based server) configured to analyze the captured images of the eyes and determine the gaze direction and/or other eye tracking details. In such examples, a processed result indicating a gaze direction and/or other eye tracking information may be sent to the display controller. The eye tracking information, whether received by or determined at the display controller, may be used by the display controller to control one or more display characteristics. The display characteristics may include a location of display data (e.g., to be within a gaze direction), localized dimming control (e.g., dimming backlighting in regions that are outside of a gaze direction), a content of display data (e.g., using the gaze direction to determine selections on a graphical user interface and rendering content corresponding to the selections on the graphical user interface), and/or other display characteristics. In some examples, other eye tracking data may be used to adjust the display characteristics, such as adjusting a visibility (e.g., opacity, size, etc.) of displayed data responsive to detection of a user squinting.

Sunload monitoring module 118 may include and/or be in communication with one or more sun detection sensors, such as infrared sensors, to determine an amount of sunlight (or other light) impinging on the windshield and/or display elements. As described above with respect to the image sensors and eye tracking data, sunload monitoring data may be processed locally (e.g., by the sunload monitoring module 118, by the display controller 114, and/or by another in-vehicle processing module, such as a processing module of a head unit of the vehicle 104), remotely (e.g., by a remote service outside of the vehicle, such as a cloud-based server), and/or some combination thereof. The sunload monitoring data may include an amount of sunlight (or other light) in a given region of the vehicle that is associated with the display configuration (e.g., display units, regions of the windshield onto which display light from the display 108 may be projected, other locations in a path of light emitted from the display 108, etc.). The amount of light may be compared to one or more thresholds and used by the display controller 114 to adjust one or more display characteristics. For example, if sunload in a particular region of the windshield is above a threshold, the display controller and/or another suitable controller may adjust a physical position of an optical element (e.g., the 3D element 112) to increase a focal length of the display configuration and reduce a magnification of the optics of the display configuration, thereby decreasing a sunload on the display elements (e.g., a thin-film-transistor, TFT, of an LCD display).

The user input interface 120 and vehicle input interface 122 may be used to provide instructions to the display controller 114 to control the display based on user input and vehicle data/status, respectively. For example, user input to change a type of information displayed (e.g., to select between instrument data such as speed/RPM/etc. and navigation data such as turn directions), to select options when a graphical user interface is displayed, and/or to otherwise indicate user preferences may be provided to the display controller 114 and processed to alter a content and/or format of the data displayed via the display unit 107. The user input interface may receive user input from any suitable user input device, including but not limited to a touch screen, vehicle-mounted actuators (e.g., buttons, switches, knobs, dials, etc.), a microphone (e.g., for voice commands), an external device (e.g., a mobile device of a vehicle occupant), and/or other user input devices. The vehicle input interface 122 may receive data from vehicle sensors and/or systems indicating a vehicle status and/or other vehicle data, which may be sent to the display controller 114 to adjust content and/or format of the data displayed via the display system 102. For example, a current speed may be supplied (e.g., via a controller-area network, CAN, bus of the vehicle) to the vehicle input interface and sent to the display controller to update a display of a current speed of the vehicle. The vehicle input interface may also receive input from a navigation module of a head unit of the vehicle and/or other information sources within the vehicle.

Camera 128 may provide digital images to display controller 114 for tracking objects that may be in the path of vehicle 104. In some examples, two cameras may provide digital images to display controller 114. Camera 128 may capture digital images and transfer the digital images to display controller 114 at a fixed rate (e.g., every 16 milliseconds (ms)).

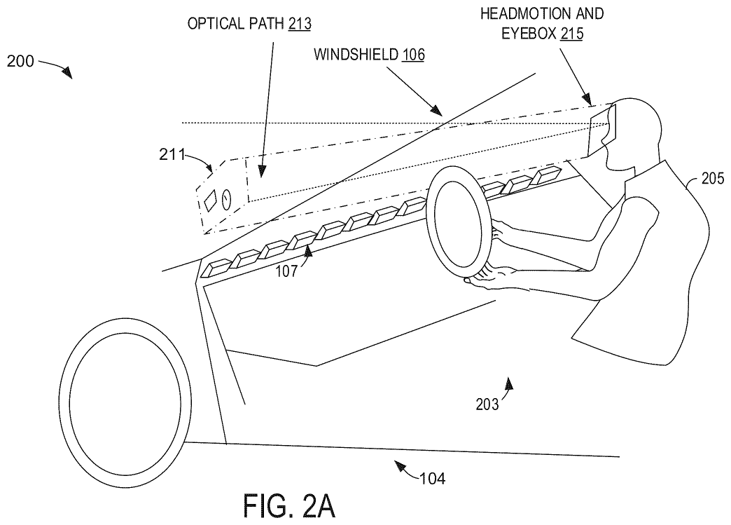

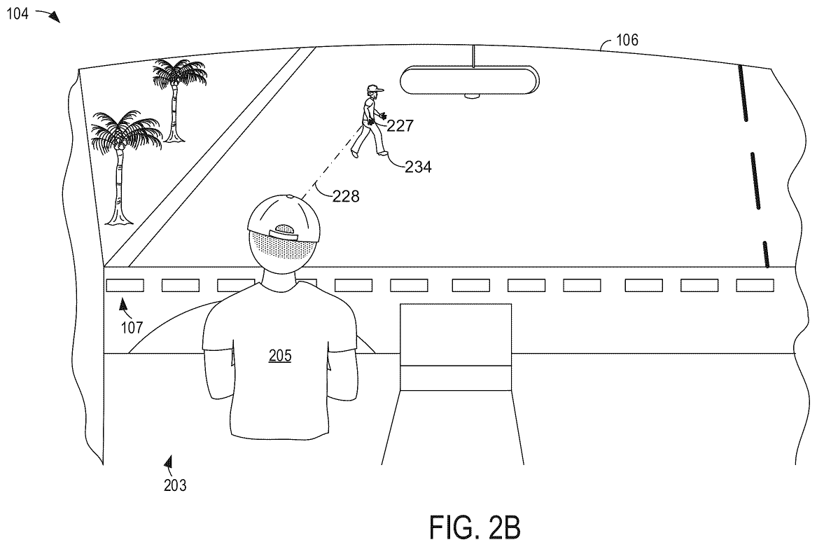

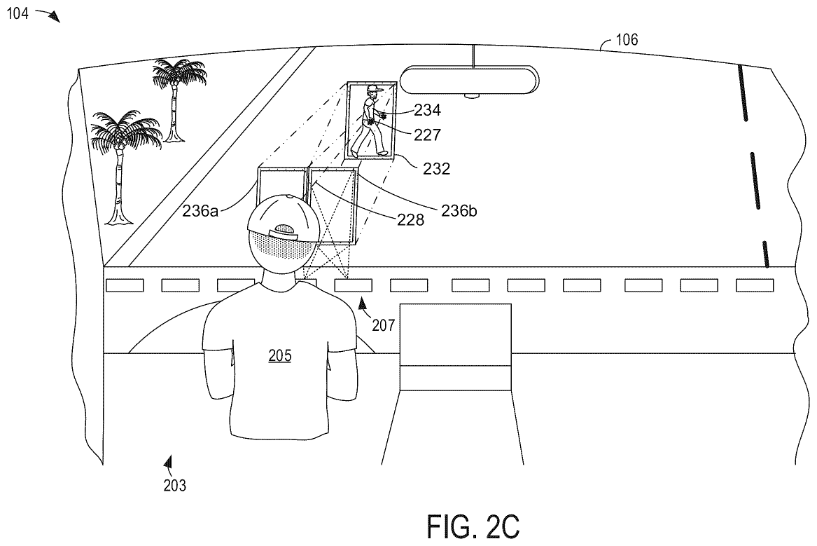

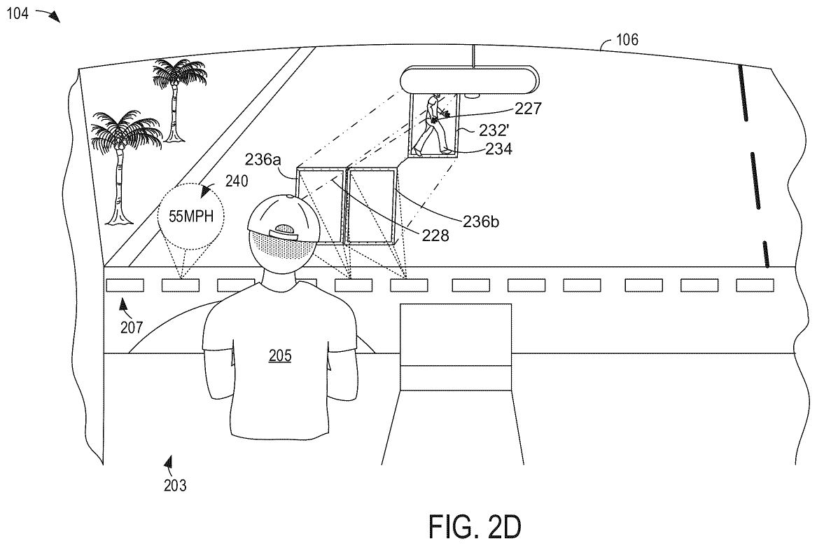

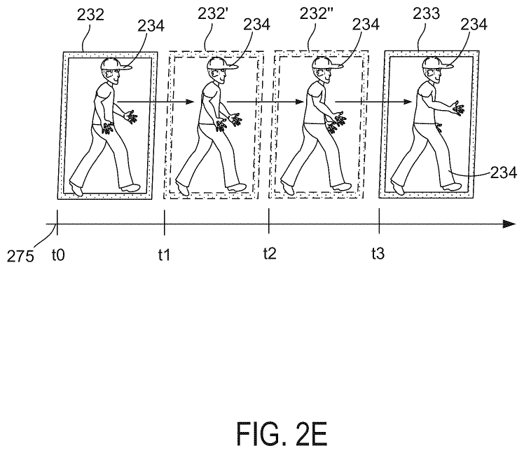

Referring now to FIG. 2A, a schematic representation of a cabin 203 of vehicle 104 is shown, in which a user 205 is seated. A plurality of display units 107 are distributed across the windshield 106 (e.g., to form an array of display units 107) to control image light to appear in a position that is viewable through the windshield 106 to appear at a virtual location 211. The virtual location 211 may be controlled to be within an optical path 213 that originates from a headmotion and eyebox 215 of the user 205 and represents at least a portion of a visual viewable range of the user 205 (e.g., an area that user 205 may view objects). As described above with respect to FIG. 1, each display unit 107 may include a display (e.g., display 108) with an array of backlights (e.g., backlight 109), one or more micro lens arrays (e.g., micro lens array 110a and/or 110b, and a 3D element (e.g., 3D element 112) positioned between the display and the micro lens array(s). Each display unit 107 may be controlled by an individual display controller (e.g., display controller 114) and/or a single display controller may control the display of each display unit 107. The area in which display units 107 may project light to generate images comprised of photons may be referred to as being in the field of projection of the heads-up display.

FIG. 2A shows an example augmented reality environment 200, in which an in-vehicle display system 102 of a vehicle 104 is controlled to project virtual images into an environment of a user 205. The environment in the illustrated example is a vehicle, however it is to be understood that one or more of the below-described components may be included in a display configuration that is used in another augmented reality environment without departing from the scope of this disclosure.

FIG. 2A shows a schematic representation of a passenger cabin 203 of vehicle 104, in which a user 205 is seated. A plurality of display units 107 are distributed across the windshield 106 (e.g., to form an array of display units 107) to control image light to appear in a position that is viewable through the windshield 106 to appear at a virtual location 211. The virtual location 211 may be controlled to be within an optical path 213 that originates from a headmotion and eyebox 215 of the user 205 and represents at least a portion of a viewable range of the user 205. As described above with respect to FIG. 1, each display unit 107 may include a display (e.g., display 108) with an array of backlights (e.g., backlight 109), one or more micro lens arrays (e.g., micro lens array 110a and/or 110b, and a 3D element (e.g., 3D element 112) positioned between the display and the micro lens array(s). Each display unit 107 may be controlled by an individual display controller (e.g., display controller 114) and/or a single display controller may control the display of each display unit 107.

The system of FIGS. 1-2A provides for a heads-up display device comprising: a display; a camera; and a display controller comprising a processor and memory storing non-transitory instructions executable by the processor to exhibit one or more virtual objects via the display, the one or more virtual objects generated via the processor, the one or more virtual objects exhibited in displayed images via the display at a rate faster than new images are captured via the camera, and where positions of the one or more virtual objects are adjusted in each of the displayed images each time the displayed images are updated. In a first example, the heads-up display device may include wherein the new images are images are captured at a fixed rate. A second example optionally includes the first example, and wherein a position of the one or more virtual objects is based on a position of an identified object in an image captured via a camera, and wherein the one or more virtual objects are configured to make an object in the real-world more noticeable. A third example optionally includes one or both of the first example and the second example, and wherein the one or more virtual objects appear to surround the object in the real-world. A fourth example optionally includes one or more of the first through third examples, and where the one or more virtual objects are placed to appear proximate to the object in the real-world via the heads-up display. A fifth example optionally includes one or more of the first through fourth examples, and further comprises additional instructions to position the one or more virtual objects generated via the processor via the heads-up display based on a trajectory of a first identified object captured in a first image via the camera and the first identified object captured in a second image via the camera. A sixth example optionally includes one or more of the first through fifth examples, and wherein the trajectory of the first identified object is based on a position of the first identified object in the first image and a position of the first identified object in the second image. A seventh example optionally includes one or more of the first through sixth examples, and further comprises additional instructions to resize the one or more virtual objects in response to the trajectory of the first identified object.

Turning now to FIG. 2B, a view on an interior of the cabin 203 of vehicle 104 is schematically shown from a different rear perspective relative to the cabin 203 as schematically shown in FIG. 2A. In the example of FIG. 2B, the cabin 203 includes one user 205 or occupant, but display units 107 may project light to produce see-through images for two or more occupants. User 205 may have a user focal point 227 that targets the same object 234 (e.g., a human) in an environment of the vehicle 104. User 205 has an eye gaze path 228 for viewing focal point 227, and the eye gaze path 228 and focal point may change as user 205 visually follows object 234. Accordingly, the display units 207 may direct light onto the windshield 106 differently so that virtual objects (not shown) may move as object 234 moves.

FIG. 2C shows an exemplary projection for overlaying a virtual image or virtual object 232 (e.g., a targeting box or other visual aid) on a real-world object 234, such as a human using stereoscopic images 236a and 236b. The stereoscopic images 236a and 236b are configured for presenting the virtual image 232 at the user focal point 227 from the perspective of user 205. In the illustrated example, such positioning is achieved through the coordinated use of the center left display units 207. The virtual object may act to draw attention to or to highlight object 234. By highlighting object 234, attention of user 205 may be heightened so that user 205 may avoid object 234. Although object 234 is depicted as a human, object 234 may be another vehicle, animal, sign, traffic signal, or other movable or immovable object. The virtual object 232 may be visible by looking through windshield 106 of vehicle 104.

FIG. 2D shows placement of the virtual image 232′ in an alternative position. In particular, virtual image 232′ may be configured to track a position of a real-world object 234 as the real-world object 234 moves in the environment (or as the vehicle moves in relation to the real-world object through the environment). FIG. 2D shows an example of a movement of stereoscopic images 236a/b in order to maintain alignment of the virtual image 232′ with the position of the object 234 according to the gaze path 228 of user 205 as the position of the object 234 moves relative to the vehicle 104 in the real-world. As shown, the relative positioning of the stereoscopic images 236a/b and the object 234 in FIG. 2D may be substantially to scale to show the movement of the object 234 in the real-world and the resulting movement of the stereoscopic images (and the resulting virtual object image 232′) to maintain alignment with the object 234 as viewed from the perspective of the user 205.

FIG. 2D also shows an example scenario in which multiple display units may be used to project multiple images via the windshield 106, enabling a large portion of the windshield 106 (e.g., an entirety of the windshield) to be used as a display surface. For example, in addition to the stereoscopic images 236a/b, another display unit may project a current speed indicator 240 (e.g., a display unit on the left end of the windshield) or other image, and still other display units may project other images (not shown). The speed indicator 240 may be displayed in a near-field (e.g., in a different field relative to the virtual image 232′), while the virtual image 232′ may be displayed in a far-field. As illustrated, the number of display units used to display a given image may vary. In some examples, the display units used to display various virtual images or indicators on/through the windshield 106 may be greater than the number of virtual images and/or indicators displayed on/through the windshield. In other examples, the same number or fewer display units may be used to display the number of virtual images and/or indicators displayed on/through the windshield 106. The number of display units used to display a given virtual image or set of virtual images may depend on parameters of the virtual image(s), such as a size, resolution, content, color, etc.

In the illustrated example, the display units 207 are utilized to display the various images via the windshield 106, however, it is to be understood that the images may be presented using other display arrangements such as mirror based systems (not shown). In addition, the display system may generate a plurality of virtual images or objects to track a plurality of objects in the real-world.

Referring now to FIG. 2E, a high speed time sequence illustrating how a virtual image or object may adjusted between times when a new virtual image or object may be displayed using object information from a newly captured image. FIG. 2E includes a time line 275 where times t0-t3 are indicated.

At time t0, virtual image or object 232 is displayed and laid over object 234 according to a position of object 232 as determined from a most recently captured camera image. Virtual image or object 233 is a next most recent virtual image or object that may be displayed and laid over object 234 according to a next most recent position of object 232 as determined via a newest or most recently captured camera image following the display of virtual image or object 232. In other words, virtual images or objects 232 and 233 may be the first objects or images displayed and placed over object 234 after a camera has captured a new image. Virtual images or objects 232, 232′, 232″, and 233 are the same virtual images or objects displayed at different times in the illustrated sequence.

Due to hardware and constraints and processing limitations, it may take a greater amount of time to display virtual images or objects that are based on newest captured images than may be desired. In particular, user 205, as shown in FIG. 2D, may be able to visually recognize step-wise changes in the displayed positions of virtual images or objects 232 and 233 if virtual images or objects 232′ and 232″ are not displayed. In addition, virtual image or object 232 may noticeably lag behind object 234 if virtual images or objects 232′ and 232″ are not displayed. However, FIG. 2E illustrates how virtual images or objects 232′ and 232″ may be displayed so that object 234 may be more closely followed. Specifically, virtual images or objects 232′ and 232″ may be displayed according to an estimated trajectory of object 234 so that processing of additional camera images may be avoided.

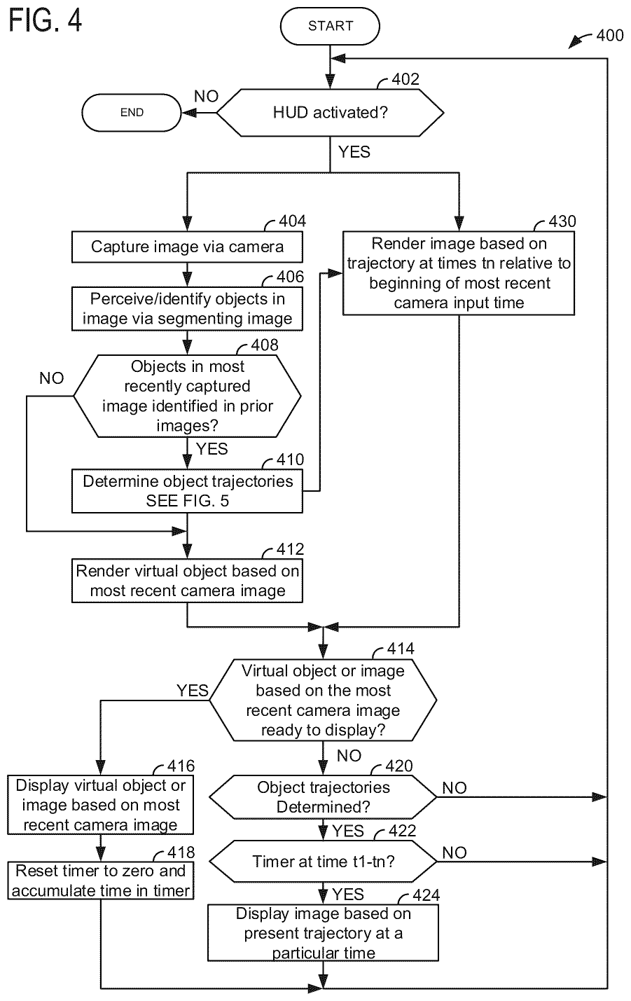

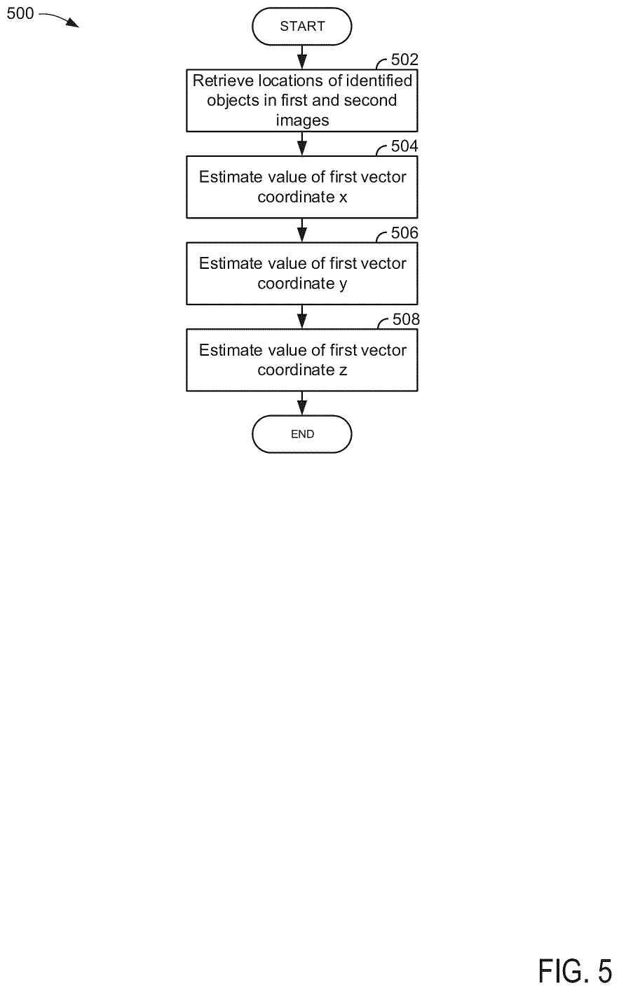

The display positions of virtual objects 232′ and 232″ may be determined according to an estimated trajectory of object 234 as described in the methods of FIGS. 4 and 5. Consequently, the displayed positions of virtual objects 232′ and 232″ may fill the time in between time t0 and time t3 so as to visually smooth the presentation of the virtual objects so that object 234 may be followed more closely.

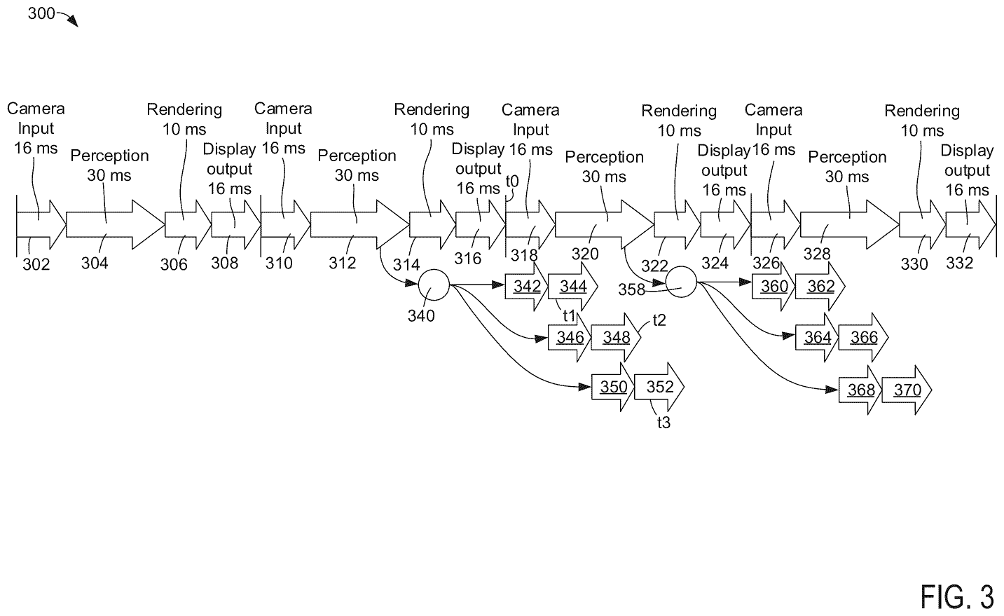

FIG. 3 shows a timing diagram 300 including sequence steps and timing for identifying an object and displaying a virtual object or image in the visual vicinity of the identified object from a user's focal point or point of view. Time increase from the left side of FIG. 3 to the right side of FIG. 3. Sequence steps or operations are indicated by arrows and the arrows are numbered from 302 to 332. The operations that are performed in each of the steps are indicated above the steps. For example, camera input is captured at the time represented by arrow 302. Camera input may include generating a pixelated image from a light sensor within the camera and storing the image to memory (e.g., random access memory RAM). Perception of objects in the image that is captured by the camera and stored to memory occurs at step 304. Rendering of a virtual object or image occurs at step 306 and the image is exhibited via the display unit at 308. The sequence illustrated at steps 302-308 is repeatedly performed and four image capture and display cycles (e.g., one image capture and display cycle occurring each time the four operations of camera input, perception, rendering, and display are performed) of the sequence are illustrated. Vertical lines are shown at the end/beginning of each sequence cycle.

The example of FIG. 3 begins at power-up time of the heads-up display. A first image is captured at 302 and a first rendering of a virtual object is displayed at 308 if an object is identified from the image at 304. The beginning of 302 is the beginning of a first image capture and display cycle and the first image and capture display cycle ends at the end of 308. Motion of identified objects is not determined based on the initial image since there is no reference for movement of any identified objects. A second image is captured at 310 and objects, if present, may be identified at 312. If an object was identified at 304 and the same object is identified a second time at 312, the trajectory of the object and other identified objects may be determined at 340 as discussed in the method of FIGS. 4 and 5. A second rendering of the virtual object or image that is to be laid over the identified object is performed at 314, and the rendering is exhibited via the heads-up display at 316 so that the user may visually observe the identified object and the virtual object or image that tracks the identified object.

A third image capture and display cycle begins with camera input being captured at 318, which begins at time t0. However, in this image capture and display cycle, the trajectory image information or data determined at 340, from prior image capture and display cycle beginning at 310, is applied at 342 to render and update the virtual object or image that tracks with the identified object. The updated virtual object may include size and positioning updates for the virtual object. The updated virtual object is displayed at 344 beginning at time t1, and the updated virtual object is the second image that is displayed based on the image that was captured at 310. Notice that the virtual object display event at 342 occurs during the perception time 320 for the image that is presently being proceeds (e.g., the image captured at 318). By displaying an updated version of the virtual image or object sooner than at 324, a smoother progression of the virtual image or object may be presented via the heads-up display to the user. The trajectory image information or data determined at 340 is applied a second time at 346 to render and second update the virtual object or image that tracks with the identified object. The second updated virtual object may also include size and positioning updates for the virtual object. The second updated virtual object is displayed at 348 beginning at time t2, and the updated virtual object is the third image that is displayed based on the image that was captured at 310. The trajectory image information or data determined at 340 is applied a third time at 350 to render and third update the virtual object or image that tracks with the identified object. The third updated virtual object may also include size and positioning updates for the virtual object. The third updated virtual object is displayed at 352 beginning at time t3, and the updated virtual object is the fourth image that is displayed based on the image that was captured at 310. The third image captured by the camera is processed at 320 and the trajectory of the identified object, if still present, is determined a second time at 358. The first virtual image or object that is based on the identified object in the third image is displayed at 324. The sequence repeats after step 324, the end of the third image capture and display cycle, at steps 326-332 and 360-370. Thus, a heads-up display device may update sizes and positions of virtual objects multiple times for each image that is captured via a camera. In some examples, the trajectory steps (e.g., 340 and 358) and the renderings that are based on the trajectories (e.g., 342, 346, 350, 360, 364, and 368), may be processed in parallel via a second core in the controller's processor so that the operations may be performed in parallel with receiving camera input (e.g., 318), perceiving objects (e.g., 320), rendering virtual objects (e.g., 322), and displaying the virtual objects (e.g., 324).

Referring now to FIG. 4, a flowchart of a method for adjusting operation of a display system (e.g., a heads-up display) that tracks objects and displays virtual objects is shown. The method of FIG. 4 may be stored as executable instructions stored in non-transitory memory of a controller (e.g., 114) to exhibit one or more virtual objects in the real-world via one or more light sources. The method of FIG. 4 may generate images as shown in FIGS. 2C-2E in cooperation with the system of FIGS. 1 and 2A.

At 402, method 400 judges whether or not the heads-up display (HUD) is activated. The HUD may be activated via input to a user interface or automatically when a vehicle is powered up. If method 400 judges that the HUD is activated, the answer is yes and method 400 proceeds to 404 and 430. Otherwise, the answer is no and method 400 proceeds to exit.

At 404, method 400 captures an image via a camera. In one or more examples, the camera senses light via an analog light sensor and voltage levels representing photons sensed via a plurality of sensor pixels is converted into digital numeric values that are stored in controller memory, thereby representing a pixelated digital image. The digital image may be passed from the camera to the controller. Method 400 proceeds to 406.

At 406, method 400 processes the captured image and attempts to identify one or more objects that may be included in the image. In one or more examples, the captured image may be processed to segment portions of the image that correlate to objects to be identified. Segmentation borders may be provided, along with identifiers specifying an object identified within the provided borders. In an example, objects may be identified by filtering the image, detecting edges of potential objects, and comparing known objects to potential objects. In an example, a trained machine learning algorithm may be used to identify particular objects, such as pedestrians, road signs, animals, vehicles, bicycles, etc. Method 408 may identify the type of object (e.g., animal, person, vehicle, etc.), the size of the object in pixels and/or provide a bounding box, and the location of the object in the image. Method 400 proceeds to 408.

At 408, method 400 judges if objects (if any) identified in the most recently captured camera image where present in the second most recently captured camera image. If so, the answer is yes and method 400 proceeds to 410. A “yes” answer indicates that a trajectory of the identified object may be determined. If the answer is no, method 400 proceeds to 412.

At 410, method 400 determines a trajectory of each twice identified object in the most recent and second most recent images captured by the camera. The trajectories may be estimated as described in FIG. 5. Method 400 proceeds to 412 and 430.

At 412, method 400 renders virtual objects that are to be displayed based on the objects identified in the most recent captured camera image. The virtual objects to be displayed may be selected from a library of virtual objects, and the selected virtual object may be based on the identified object. The virtual objects or images may include but are not limited to target shapes (e.g., boxes, circles, etc.), poses, and icons. In one or more examples, method 400 scales the virtual objects according to the sizes of the identified objects. For example, if an identified object is 100 pixels wide and 200 pixels tall, the size of the virtual object may be Vx=Sf1*(Px), Vy=Sf2*(Py), where Vx is the width of the virtual object to be displayed, Vy is the height of the virtual object to be displayed, Px is the pixel width of the identified object, Py is the pixel height of the identified object, Sf1 is the width scaling factor between the identified object and the virtual object or image (e.g., a target box), and Sf2 is the height scaling factor between the identified object and the virtual object or image. The virtual objects may be scaled to cover the identified object, surround the identified object, or be fraction of the size of the identified object when the virtual object is exhibited and presented to the user via the HUD.

In one or more examples, the location in the field of projection of the heads-up display that a particular virtual object or image is placed may be a function of a location of the associated identified object in the most recent image captured by the camera. For example, if a center of the associated identified object is at a location 1000x, 2000y, where 1000x is 1000 pixels from a camera light sensor horizontal reference position (e.g., a particular corner of the sensor), and where 2000y is 2000 pixels from a camera light sensor vertical reference position, the field of projection of the heads-up display including position at which the particular virtual object or image is placed may be determined via a function (Hx,Hy)=MAP(x,y), where Hx is a horizontal location in the HUD field of projection, Hy is a vertical location in the HUD field of projection, x is the camera sensor horizontal pixel location for the center of the identified object, and y is the camera sensor vertical pixel location for the center of the identified object, and MAP is a function that maps camera sensor pixel locations to HUD field of projection locations. Method 400 proceeds to 414.

At 414, method 400 judges if virtual objects or images based on the most recently captured camera image are ready to display via the HUD. For example, as shown in FIG. 3, method 400 may judge if virtual images or objects based on the image captured at step 318 are prepared for display or exhibition to users as shown at 324. If so, the answer is yes and method 400 proceeds to 416. Otherwise, the answer is no and method 400 proceeds to 420.

At 416, method 400 exhibits or displays virtual objects or images based on the most recently captured camera image to users via the HUD. The objects or images may be exhibited at a location in the heads-up field of projection where the user sees the virtual object or image and the identified object. For example, from the user's perspective, a virtual object or image may be displayed such that it appears to surround the identified object as shown at 232 of FIG. 2E. Thus, the position of a virtual object in a display field may be based on a position of an identified object in a camera image. In one or more examples, a position of a virtual object or image may be based on a mapping between locations (e.g., pixel locations) on the camera sensor to locations in the heads-up display field of projection (e.g., (Hx,Hy)=MAP(x,y) as previously described). Method 400 proceeds to 418.

At 418, method adjusts a value of time tn to be equal to a value of zero and time begins to accumulate in the timer. Method 400 returns to 402.

At 430, method 400 renders virtual objects or images that are to be displayed based on the trajectories of objects identified in the most recent captured camera image. As previously described, the virtual objects to be displayed may be selected from a library of virtual objects, and the selected virtual object may be based on the identified object.

Method 400 may display virtual objects or images that are based on interpolated trajectories of identified objects in images that are captured via the camera a predetermined number of times between times when images are captured via the camera. For example, as shown in FIG. 3, if an amount of time taken to capture an image via a camera, perceive objects in the image, render virtual objects, and display virtual objects is 76 milliseconds, virtual images or objects may be display four times each 76 milliseconds including three displays that are based on interpolated trajectories of identified objects from a previously captured image and one display that is based on a most recently captured image. It should be appreciated that the actual total number of images that include virtual objects or images in an image capture and display cycle may vary depending on system hardware and processing.

The process for revising attributes (e.g., size and positioning) of a virtual object or image in a displayed image is described herein, and the process may be extended to revising attributes for displaying a plurality of virtual objects or images in a displayed image. In one or more examples, method 400 may receive a trajectory for a particular object that is a basis for displaying a virtual object or image during an image capture and display cycle. The trajectory may be the basis for determining a change in position of the virtual object or image in a displayed image. The position of the virtual object or image in the displayed images during an image capture and display cycle may be revised for each displayed image. For example, if a person is identified in a camera captured image and the person's position in the captured image is 20000x, 10000y, 5000z with a trajectory that is determined to be 5000x, 0y, and 2000z, for an image cycle of 72 milliseconds, the person's position at the camera sensor may be extrapolated to be:

$$pt 1 ( ( 20000 + \frac{1}{Du} ( \frac{5000}{72 ms} ) ) x , 10000 y , ( 5000 + \frac{1}{Du} ( \frac{2000}{72 ms} ) ) z )$$

$$pt 2 ( ( 20000 + \frac{2}{Du} ( \frac{5000}{72 ms} ) ) x , 10000 y , ( 5000 + \frac{2}{Du} ( \frac{2000}{72 ms} ) ) z )$$

$$pt 3 ( ( 20000 + \frac{3}{Du} ( \frac{5000}{72 ms} ) ) x , 10000 y , ( 5000 + \frac{3}{Du} ( \frac{2000}{72 ms} ) ) z )$$

where pt1 is the position of the estimated or expected position of the identified object at the camera sensor at time t1 of the image capture and display cycle, Du is the total number of heads-up display updates during an image capture and display cycle, x is the horizontal component of the estimated or expected position of the identified object at the camera sensor, y is the vertical component of the estimated or expected position of the identified object at the camera sensor, and z is the depth (e.g., distance away) component of the estimated or expected position of the identified object at the camera sensor, pt2 is the position of the estimated or expected position of the identified object at the camera sensor at time t2 of the image capture and display cycle, and pt3 is the position of the estimated or expected position of the identified object at the camera sensor at time t3 of the image capture and display cycle. Thus, linear extrapolation from the identified object's position at the camera sensor may be a basis for estimating the position of the identified object at times in the future.

It should be noted that the z or depth component in this example does not provide a z position relative to the camera's sensor. Rather, the z component may be a basis for resizing the virtual object or image based on a change in size of the identified object between two images. Alternatively or in addition, the virtual object may be resized as a function of vehicle speed. For example, if a base size of a virtual image or object is 200 horizontal pixels by 300 vertical pixels, the virtual image or object may be scaled to a size via the following function: St1(x, y)=Rsize(Vx, Vy), where St1 is the new size of the virtual image or object, x is the camera sensor horizontal pixel distance, y is the camera vertical pixel distance, Rsize is a function that returns a resized virtual object or image, Vx is a base horizontal size of the virtual object or image, and Vy is a base vertical size of the virtual object or image. Thus, method 400 does not rely on the determination of absolute positions and sizes of identified objects. Rather, it may rescale virtual objects and images according to changes in sizes of the identified objects so as to simplify calculations. However, in some examples, method 400 may estimate the absolute size of an identified object and absolute distances to the identified objects, relative to the camera, to estimate positions and sizes of identified objects at times in the future. Method 400 renders images of virtual objects and images based on expected positions of identified objects in captured camera images based on the expected positions and new size values. Method 400 proceeds to 414.

At 420, method 400 judges if trajectories of identified objects from the most recent camera image capture have been determined. If so, the answer is yes and method 400 proceeds to 422. Otherwise, the answer is no and method 400 returns to 402. A “no” answer may be provided when the HUD system starts as shown in FIG. 3.

At 422, method 400 judges if the timer is at a value that is equal to time t1, t2, t3-tn. The times t1, t2, t3-tn may be fixed times that are based on system hardware, data processing capabilities, and desired refresh rates. If method 422 judges that the value of the timer is equal to t1-tn, the answer is yes and method 400 proceeds to 424. Otherwise, the answer is no and method 400 returns to 402. It should be noted that the value of the timer does not have to equal exactly the time t1, t2, or tn to proceed to 424. For example, if the value of the timer is equal to or greater than time t1 and the virtual object or image position for time t1 has not been displayed, method 400 proceeds to 424. However, if the value of the timer is greater than time t1, but less than time t2 and the virtual object or image for time t1 has been displayed, method 400 may return to 402 until the value of the timer is greater than or equal to time the time t2.

At 424, method 400 displays the virtual objects or images based on the time t1-tn that the value of the timer is presently closest to. For example, if time t2 is 26 milliseconds (ms) and the amount of time in the timer is 26.01 milliseconds, method 400 displays the virtual objects or images based on the identified objects positions at time t2 as determined at 430. Therefore, if the value of the timer is equal to time t2 (e.g., 26 ms), then the positions of virtual objects or images in the heads-up display field of projection may be determined via the following mapping (Hx,Hy)=MAP(x,y) as previously described, where the value of x and y may be determined from positions pt1, pt2, pt3, or ptn previously mentioned. The sizes of the virtual objects or images may be determined as previously described at 430. Method 400 returns to 402.

In this way, virtual objects or images may be positioned in a heads-up display field of view based on positions of identified objects in an image that is captured via a camera. The positions of the virtual objects or images in the heads-up display field may be based on estimates of where an identified object will be at a future time.

Referring now to FIG. 5, a flowchart of a method for estimating a position of an identified object on a camera sensor is shown. The method of FIG. 5 may be stored as executable instructions stored in non-transitory memory of a controller (e.g., 114) to exhibit one or more virtual objects in the real-world via one or more light sources. The method of FIG. 5 may estimate positions of images where one or more identified objects are predicted or expected to be at a later time on a camera sensor that captures images for a camera.

At 502, method 500 retrieves locations of identified objects in a first image and locations of the identified objects in a second image from step 406, the second image a next image captured after the first image. The locations of the identified objects may be based on pixel locations of the identified objects in the captured image. The pixel locations in the captured image that includes the identified objects may be the same pixel locations of the camera sensor. For example, pixel (1000, 2000) of the camera sensor may correspond to pixel (1000, 2000) of the captured image. The locations of the identified objects in the first and second images may be the center of pixel areas that make up the identified objects. Method 500 proceeds to 504.

At 504, method 500 determines the x (e.g., horizontal axis) components of the identified objects from the locations of the identified objects in the first and second images. For example, if the horizontal pixel location of an identified object in a first image is 3000 and if the horizontal pixel location of the identified object in a second image is 3500, the x trajectory of the identified object may be x2−x1 or 3500−3000=500x. Method 500 proceeds to 506.

At 506, method 500 determines the y (e.g., vertical axis) components of the identified objects from the locations of the identified objects in the first and second images. For example, if the vertical pixel location of the identified object in the first image is 200 and the vertical pixel location of the in the identified object in the second image is 300, the y trajectory of the identified object may be y2−y1 or 300−200=100y. Method 500 proceeds to 508.

At 508, method 500 determines the z (e.g., depth axis) components of the identified objects from the locations of the identified objects in the first and second images. The z component of an identified object may be determined from a size of an identified object, and size of an identified object may be determined from an actual total number of pixels that represent or make up the image of the identified object on the camera sensor. For example, if the identified object occupies or covers 2000 pixels in the first image and if the identified object occupies or covers 3000 pixels in the second image, the z trajectory of the identified object may be z2−z1 or 3000−2000=1000z. Method 500 proceeds to exit.

In this way, method 500 may estimate trajectories of identified objects in images captured by the camera so that the size and position of virtual objects and images that are to be exhibited via a heads-up display in a heads-up display field of projection may be determined. Method 500 does not require absolute size or distance information of identified objects to be determined. As such, method 500 may reduce computational time. However, if desired, the sizes of identified objects and the position of the identified objects relative to camera position may be determined and used as a basis for estimating positions of the identified objects.

The methods of FIGS. 4 and 5 provide for a method for operating a heads-up display device, the method comprising: capturing a first image via a camera; identifying an object in the first image; generating a display image via a heads-up display, the display image including a virtual object that is placed in the display image based on a motion of the object. In a first example, the method includes where the motion of the object is based on a trajectory of the object, and further comprises capturing a second image via the camera and identifying the object in the second image. A second method may include the first example and it further comprises estimating the motion of the object based on the first and second images. A third example of the method may include one or both of the first and second example, and it further comprises adjusting a position of the virtual object in the display image based on the motion of the object. A fourth example may include one or more of the first through third examples, and it may further comprise adjusting a size of the virtual object based on a speed of a vehicle. A fifth example may include one or more of the first through fourth examples and it may include where the virtual object is configured to enhance visual identification of the object. A sixth example may include one or more of the first through fifth examples and it may include where placing the virtual object in the display image based on the motion of the object includes placing the virtual object in the display image based on a location the object is expected to be, the location the object is expected to be being based on a position of the object in the first image.

The methods of FIGS. 4 and 5 provide for a method for operating a heads-up display device, the method comprising: capturing a first image via a camera; identifying a position of an object in the first image; generating a first image via a heads-up display, the first image including a virtual object that is placed in the first image at a first position based on the position of the object in the first image; capturing a second image via the camera; identifying a position of the object in the second image; generating a second image via a heads-up display, the second image including the virtual object that is placed in the second image at a second position based on the position of the object in the second image; and generating a plurality of images via a heads-up display, the plurality of images generated at times between generation of the first image and generation of the second image, the plurality of images including the virtual object, the virtual object placed in the plurality of augmented images based on expected positions of the object, the expected positions of the object located between the first position and the second position. In a first example, the method includes where the expected positions of the object are based on the position of the object in the first image. A second example may include the first example and where the expected positions of the object are based on the position of the object in an image captured via the camera before the first image. A third example may include one or more of both of the first and second example, and it may further comprise adjusting a size of the virtual object based on a change in a size of the object. A fourth example may include one or more of the first through third examples, and it may further comprise estimating a position change of the object.

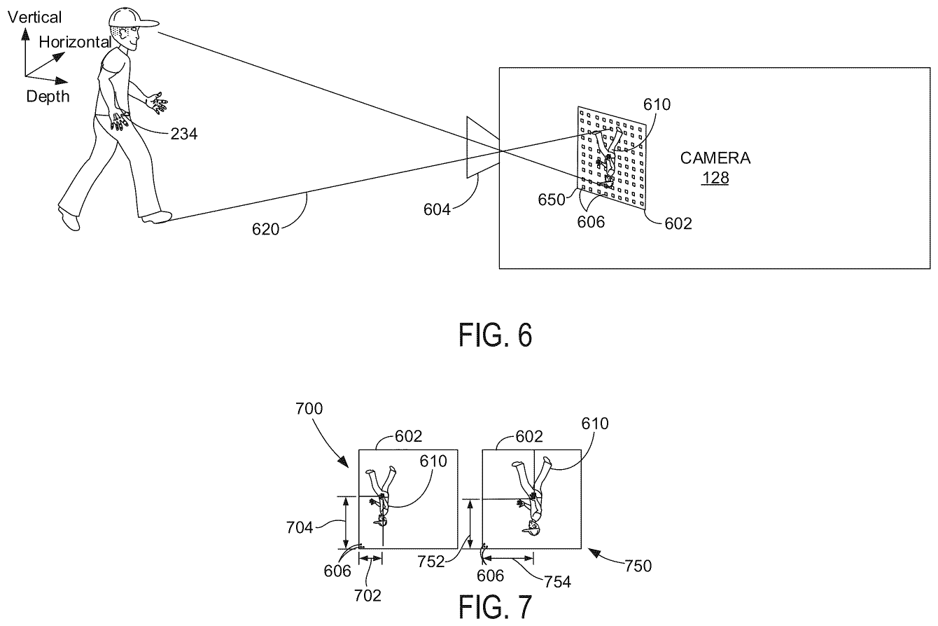

Referring now to FIG. 6, a schematic view showing how a camera may capture an image that includes an identified object is shown. In this example, an image of identified object 234 (e.g., a person) is delivered to image sensor 602 via reflected light 620 that is focused via lens 604. Image 610 of object 234 is focused on pixels 606 of sensor 602. Pixels may be referenced to a particular location 650 (e.g., lower left corner) on image sensor 602. Voltage levels output from sensor 602 may be indicative of photons that are received via camera sensor 602. In some examples, filters (not shown) may determine which colors in a color spectrum (e.g., red, blue, green) may reach specific pixels in image sensor 602.

Referring now to FIG. 7, two images that may be a basis for determining a trajectory of an identified object are shown. In this example, first image 700 is captured at a first time at a beginning of a first image capture and display cycle and second image 750 is captured at a second time at a beginning of a second image capture and display cycle that immediately follows the first image capture and display cycle. The amount of time between when the first image is captured and the time when the second image is captured may be 72 milliseconds or another system dependent time.

A first image 700 includes image 610 of object 234. Likewise, second image 750 includes image 610 of object 234. A center of object 234 is at a horizontal distance 702 away from the lower left corner (e.g., the reference location) of camera sensor 602 in first image 700. The center of object 234 is a horizontal distance 754 away from lower left corner of camera sensor 602 in second image 750. The center of object 234 is a vertical distance 704 away from lower left corner of camera sensor 602 in first image 700. The center of object 234 is a vertical distance 752 away from lower left corner of camera sensor 602 in second image 750. Thus, the x (e.g., horizontal) position and y (vertical) position of object 234 has changed from first image 700 to second image 750. In addition, the size of object 234 has increased from the first image 700 to the second image 750, which may indicate that object 234 is moving toward camera 128. In this way, a position and size of object 234 in first and second images may be indicative of a trajectory and motion of object 234.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the display controller 214 described with reference to FIG. 2A. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A heads-up display device comprising:
a display;
a camera; and
a display controller comprising a processor and memory storing non-transitory instructions executable by the processor to exhibit one or more virtual objects via the display, the one or more virtual objects generated via the processor, the one or more virtual objects exhibited in displayed images via the display at a rate faster than new images are captured via the camera, and where positions of the one or more virtual objects are adjusted in each of the displayed images each time the displayed images are updated.

2. The heads-up display device of claim 1, wherein the new images are images are captured at a fixed rate.

3. The heads-up display device of claim 1, wherein a position of the one or more virtual objects is based on a position of an identified object in an image captured via the camera, and wherein the one or more virtual objects are configured to make a real-world object more noticeable.

4. The heads-up display device of claim 3, where the one or more virtual objects appear to surround the real-world object.

5. The heads-up display device of claim 3, where the one or more virtual objects are placed to appear proximate to the real-world object via the heads-up display device.

6. The heads-up display device of claim 1, further comprising additional instructions to position the one or more virtual objects generated via the processor via the heads-up display device based on a trajectory of a first identified object captured in a first image via the camera and the first identified object captured in a second image via the camera.

7. The heads-up display device of claim 6, where the trajectory of the first identified object is based on a position of the first identified object in the first image and a position of the first identified object in the second image.

8. The heads-up display device of claim 7, further comprising additional instructions to resize the one or more virtual objects in response to the trajectory of the first identified object.

9. A method for operating a heads-up display device, the method comprising:
capturing a first image via a camera;
identifying an object in the first image; and
generating a display image via a heads-up display, the display image including a virtual object that is placed in the display image based on a motion of the object.

10. The method of claim 9, where the motion of the object is based on a trajectory of the object, and further comprising:
capturing a second image via the camera and identifying the object in the second image.

11. The method of claim 10, further comprising estimating the motion of the object based on the first image and the second image.

12. The method of claim 11, further comprising adjusting a position of the virtual object in the display image based on the motion of the object.

13. The method of claim 12, further comprising adjusting a size of the virtual object based on a speed of a vehicle.

14. The method of claim 13, where the virtual object is configured to enhance visual identification of the object.

15. The method of claim 9, where placing the virtual object in the display image based on the motion of the object includes placing the virtual object in the display image based on a location the object is expected to be, the location the object is expected to be being based on a position of the object in the first image.

16. A method for operating a heads-up display device, the method comprising:
capturing a first image via a camera;
identifying a position of an object in the first image;
generating a second image via a heads-up display, the second image including a virtual object that is placed in the second image at a first position based on the position of the object in the first image;
capturing a third image via the camera;
identifying a position of the object in the third image;
generating a fourth image via a heads-up display, the fourth image including the virtual object that is placed in the fourth image at a second position based on the position of the object in the third image; and
generating a plurality of images via a heads-up display, the plurality of images generated at times between generation of the second image and generation of the fourth image, the plurality of images including the virtual object, the virtual object placed in the plurality of images based on expected positions of the object, the expected positions of the object located between the first position and the second position.

17. The method of claim 16, where the expected positions of the object are based on the position of the object in the first image.

18. The method of claim 17, where the expected positions of the object are based on the position of the object in an image captured via the camera before the first image.

19. The method of claim 16, further comprising adjusting a size of the virtual object based on a change in a size of the object.

20. The method of claim 16, further comprising estimating a position change of the object.
